(19) United States
(12) Patent Application Publication
(10) Pub. No.: US 2016/0250739 A1
(43) Pub. Date: Sep. 1, 2016

(54) LOW-NOISE HYDRAULIC HAMMER

(71) Applicant: S.M METAL CO., LTD., Ansan-si Gyeonggi-do (KR)

(72) Inventor: Sung Kew KIM, Ansan-si, Gyeonggi-do (KR)

(73) Assignee: S.M METAL CO., LTD., Ansan-si, Gyeonggi-do (KR)

(21) Appl. No.: 15/027,460

(22) PCT Filed: Nov. 21, 2014
(86) PCT No.: PCT/KR2014/011293

§ 371 Date: Apr. 6, 2016

(30) Foreign Application Priority Data
Nov. 28, 2013 (KR) 10-2013-0146192

(51) Int. Cl. B25D 17/11; B25D 9/04

(52) U.S. Cl. CPC B25D 17/11; B25D 9/04; B25D 2217/0015; B25D 2217/0023

(57) ABSTRACT

The present invention relates to a hydraulic hammer, and more specifically, to a low-noise hydraulic hammer, wherein an impact bar that is accommodated inside of a piston is inclined so as not to contact the inside of the piston thereby preventing cracks, and a noise insulating material or a heat sink is installed inside the piston or outside the impact bar, thereby reducing noise and improving heat radiation performance.

### TECHNICAL FIELD

The present invention relates to a hydraulic hammer, and more specifically to a low-noise hydraulic hammer, capable of preventing cracks by inclining an impact bar received in a piston not to make contact with an inner part of the piston, and reducing noise and improving heat radiation performance by mounting a noise insulating material or a hint sink inside the piston or outside the impact bar.

### BACKGROUND ART

In general, a hydraulic hammer, such as a rock drill or an excavator, is essentially used to effectively perform a crushing or excavating work in various civil engineering works.

As shown in FIG. 1, the hydraulic hammer includes a housing 1, a cylinder 2 and a piston 3 provided in the housing 1 to operate using oil pressure or air pressure, and a striking part 4 provided at the front of the cylinder 2, struck by the piston 3, and having a pointed tip to perform the excavating or crushing work. When the piston 3 coupled to the cylinder strikes the striking part 4 in the excavating work using the oil pressure, noise and vibration extremely seriously occur. Noise of 80 dB or more causes a worker or inhabitants to have extremely severe unpleasant feeling and exerts an advert influence on a worker or inhabitants.

In order to solve the above problem, according to the related art, as shown in FIG. 2, a receiving part 5 is formed with a predetermined diameter and a depth at an end of the piston 3 of the cylinder 2 provided in the housing 1 to operate using the oil pressure or the air pressure, and an impact bar 6 mounted on the striking part 4 is inserted into the receiving part 5 as shown in FIG. 2.

In other words, the impact bar 6 which is a portion of the striking part 4 is inserted into the piston 3.

In this case, the piston 3 is moved forward to strike the impact bar 6 mounted on the striking part 4, and the striking is performed in the receiving part 5, so that the noise may be significantly attenuated.

However, according to the related art, since the impact bar is inserted into the piston as described above, the outer surface of the impact bar mutually makes contact with the inner surface of the piston so that the impact bar and the piston may be cracked. This is because the striking part may be moved forward and backward in a direction inclined at a predetermined angle instead of a correct linear direction.

Accordingly, as described above, cracks may be made, and heat radiation may be difficult in the configuration of the conventional receiving part, so that durability and strength may be degraded.

Meanwhile, since the hydraulic hammer is a well-known technology, and described in detail in the following prior art, the detailed description and drawings of the hydraulic hammer will be omitted in the specification of the present invention.

### DISCLOSURE

### Technical Problem

The present invention is made in order to solve the above-described problems, and an object of the present invention is to provide a low-noise hydraulic hammer in which an impact bar and an inner part of a piston are inclinedly formed to being prevented from being mutually scratched and to smoothly radiate heat, thereby preventing cracks and improving durability and strength.

### Technical Solution

According to the present invention, in order to accomplish the object, there is provided a low-noise hydraulic hammer including an impact bar (200) formed in a striking part (300) and inserted into a receiving part (120) in a piston (100). Both inner lateral sides of the receiving part (120) are inclinedly formed such that a diameter of the receiving part (120) is increased toward the impact bar (200), and the impact bar (200) is received in the receiving part (120) to make contact with the piston (100), formed with a diameter reduced toward the receiving part (120), and spaced apart from the both inner lateral sides of the receiving part (120) by a specific distance.

In this case, a contact part (130) serving as a bottom surface of the receiving part (120) and making contact with the impact bar (200) may protrude toward the impact bar (200) by a predetermined height, and both sides of the contact part (130) may be formed with buffer grooves (140) curved with a predetermined curvature.

Further, the receiving part (120) may be provided on one lateral side thereof with a noise insulating material (160).

In addition, the impact bar (200) may be formed on an outer lateral side thereof with a plurality of steps (220) for attenuation of noise.

Further, a contact surface (230) serving as an outer surface of the impact bar (200) and facing a bottom surface (110a) of the piston (100) may be formed to be spaced apart from the bottom surface (110a) by a predetermined distance when the contact part (130) of the receiving part (120) strikes the impact bar (200).

Further, the low-noise hydraulic hammer may further include a buffer part (400) interposed between the bottom surface (110a) and the contact surface (230), and the buffer part (400) may include a spring.

In addition, the low-noise hydraulic hammer may further include a buffer part (400) interposed between the bottom surface (110a) and the contact surface (230), and the buffer part (400) may have a shape of a porous cylinder having a specific sectional surface and including an elastic material.

In addition, the low-noise hydraulic hammer may further include a plurality of heat sinks (500) mounted on the inner lateral side of the receiving part (120) or on the outer lateral side of the impact bar (200).

Further, the heat sinks (500) may have mutually different heights.

The advantages and the features of the present invention will be apparently comprehended by those skilled in the art based on the embodiments, which are detailed later in detail, together with accompanying drawings.

The terminology and words used herein and appended claims should be not interpreted as the meanings of commonly used dictionaries, but interpreted as having meanings according to the technical sprit of the present invention under the principle that the concepts of the terminology and the words can be defined by the inventor in order to explain the present invention in the best mode.

### Advantageous Effects

As described above, according to the present invention, the impact bar and the inner part of the piston are inclinedly formed and thus prevented from being scratched due to the contact therebetween, so that the cracked can be prevented, and heat radiation performance is improved, so that the durability and the strength can be improved.

### DESCRIPTION OF DRAWINGS

FIGS. 1 and 2 are schematic views illustrating a hydraulic hammer according to the related art.

FIG. 3 is a schematic view illustrating the separation of a piston from a striking part in a hammer according to one embodiment of the present invention.

FIG. 4 is a schematic view showing the coupling between the piston and the striking part in the hammer according to one embodiment of the present invention.

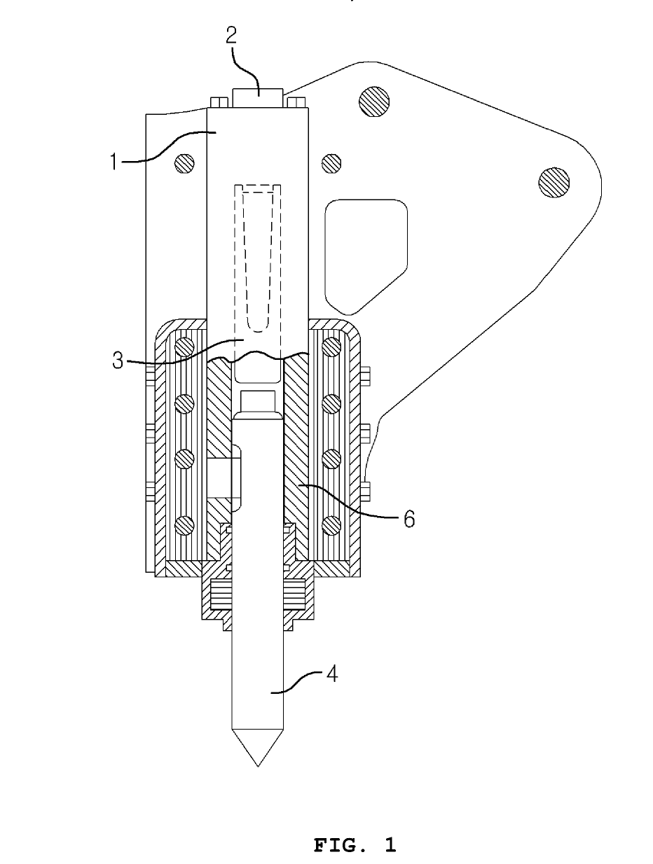

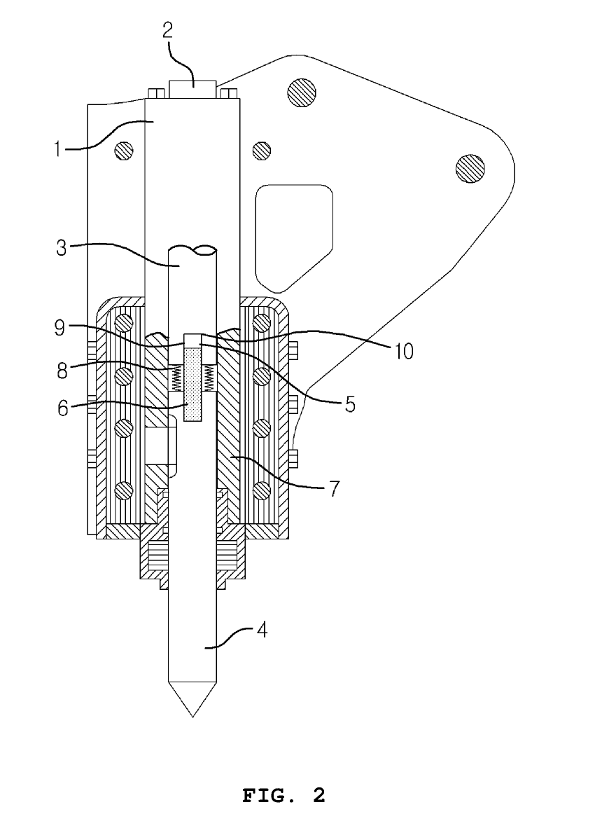

### BEST MODE

### Mode for Invention

Hereinafter, an exemplary embodiment of the present invention will be described with reference to accompanying drawings. The thickness of lines and the size of components shown in the drawings may be exaggerated, omitted or schematically drawn for the purpose of convenience or clarity.

The following terminology are defined based on functions of components according to the present invention, and may have meanings varying according to the intentions of a user or an operator and the custom in the field of art. Accordingly, the terminology should be defined based on the whole context throughout the present specification.

In addition, the following embodiments does not limit the scope of the present invention, but provided for the illustrative purpose of components defined in appended claims of the present invention. It should be understood that all modification, equivalents, or alternatives of these embodiments are included within the scope of the present inventive concept.

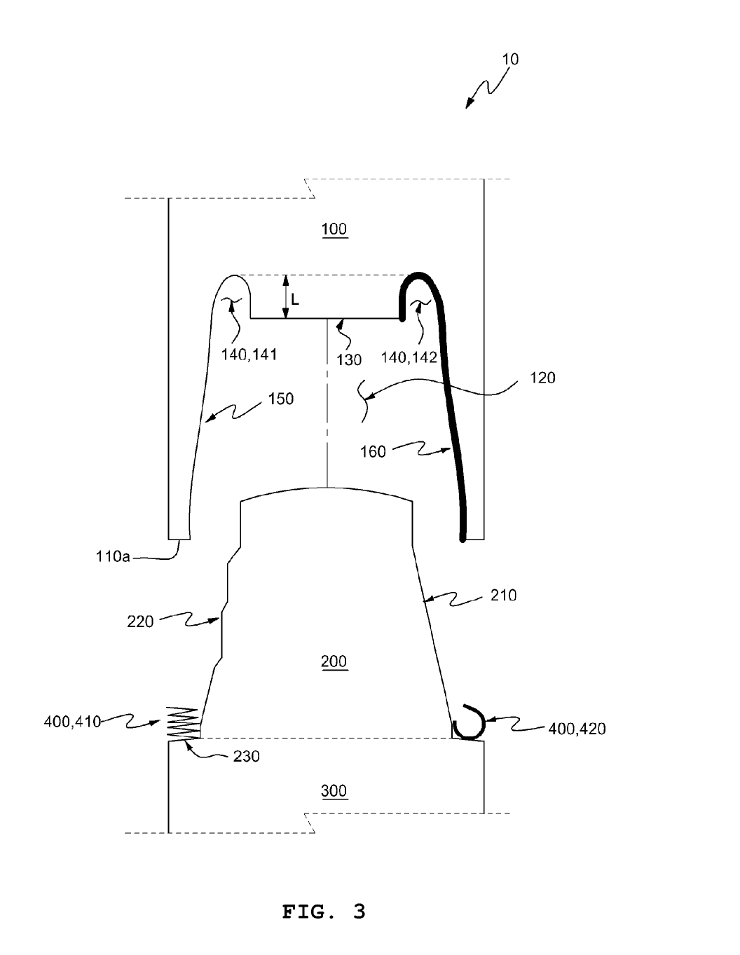

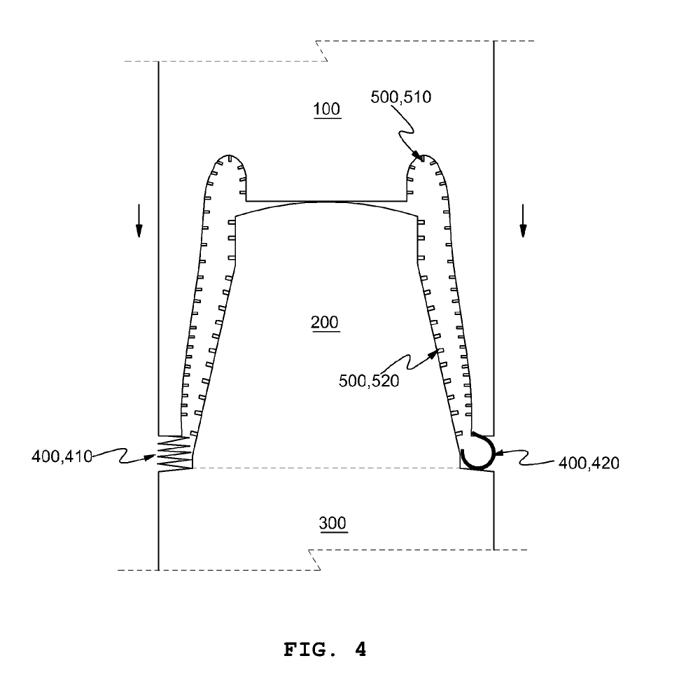

In accompanying drawings, FIG. 3 is a schematic view illustrating the separation of a piston from a striking part in a hammer according to one embodiment of the present invention, and FIG. 4 is a schematic view showing the coupling between the piston and the striking part in the hammer according to one embodiment of the present invention.

### Embodiment

A low-noise hydraulic hammer 10 according to one embodiment of the present invention has the same structure as that of the related art in that an impact bar 200 is formed in a striking part 300 and inserted into a receiving part 120 in a piston 100 as shown in FIG. 3.

In other words, the impact bar 200 protrudes from a tip of the striking part 300 to crush a workpiece, so that the impact bar 200 is inserted into the piston 100.

In this case, as the piston 100 is moved down, a contact part 130 of the receiving part 120 strikes the impact bar 200 so that the striking part 300 is moved forward and backward.

According to the present invention, both inner lateral sides of the receiving part 120 are inclined so that the diameter of the receiving part 120 is increased toward the impact bar 200. To this end, as shown in FIG. 3, the thickness of the receiving part 120 is reduced toward the impact bar 200, so that an inclination surface 150 is formed as shown in FIG. 3.

Meanwhile, the impact bar 200 received in the receiving part 120 is formed with the diameter reduced toward the receiving part 120 and thus spaced apart from both inner lateral sides of the receiving part 120 by a specific distance.

In other words, as shown in FIG. 3, the receiving part 120 has the diameter increased downward and the impact bar 200 has the diameter reduced upward. Accordingly, when viewed in the whole appearance, the outer surface of the impact bar 200 is spaced apart from the inner surface of the receiving part 120 by a predetermined distance.

According to the present invention, even if the striking part 300 is moved forward and backward while forming an inclination angle, the impact bar 200 does not make mutual contact with the inside of the receiving part 120 so that scratches are prevented, differently from that of the related art. Accordingly, cracks are prevented, differently from that of the related art, so that the durability and strength can be improved.

In addition, as described above, since the thickness of the piston 100 is reduced due to the inner inclination surface 150 of the piston 100, the weight of the piston 100 is reduced, so that the durability may be improved.

Meanwhile, the contact part 130 serving as the bottom surface of the receiving part 120 and making contact with the impact bar 200 protrudes toward the impact bar 200 by a predetermined height, and both sides of the contact part 130 may have buffer grooves 140 curved with a predetermined curvature as shown in FIG. 3.

In other words, as shown in FIG. 3, due to the contact part 130 according to the present invention more protruding downward by a distance L when comparing with that of the related art, heat may be more efficiently radiated when the contact part 130 and the top surface of the impact bar 200 strike each other.

The buffer grooves 140 curved with the predetermined curvature are formed at both sides of the contact part 130 to prevent the transfer of an impact wave when impact occurs. In other words, if the buffer grooves 140 are not formed, the impact wave formed due to the impact between the contact part 130 and the impact bar 200 is propagated to the entire portion of the piston 100. However, the buffer grooves 140 according to the present invention prevent the transfer of the impact wave, so that the strength may be improved.

Meanwhile, the buffer grooves 140 may prevent stress from being concentrated when due to the rapid change of the sectional surface thereof when formed with the predetermined curvature as described above. The buffer grooves 140 may be formed at left and right sides of the contact part 130, respectively, as shown in FIG. 3 (see reference numerals 141 and 142).

A noise insulating material 160 may be provided on one inner lateral side of the receiving part 120. In other words, as the impact bar 200 is inserted into the receiving part 120 and noise is caused due to the impact between the impact bar 200 and the receiving part 120, the noise insulating material 160 is provided on one inner lateral side of the receiving part 120 to prevent noise from being propagated.

Meanwhile, the noise insulating material 160 may include various materials in various shapes as well-known to those skilled in the art.

Meanwhile, a plurality of steps 220 for the attenuation of noise may be formed on an outer lateral side of the impact bar 200.

In other words, as shown in FIG. 3, when the steps 220 are formed with various heights on a portion of the outer lateral side of the impact bar 200, noises are mutually attenuated, so that a noise reduction effect may be improved.

In this case, the steps 220 may have a step shape, a pointed tip shape, or a curved tip shape.

In other words, the steps 220 for the attenuation of the noise according to the present invention aim at the noise reduction resulting from mutually attenuation of noises. Accordingly, as long as the steps 220 achieve the noise reduction, the steps 220 may have various shapes within the scope of the present invention.

Meanwhile, a contact surface 230 serving as an outer surface of the impact bar 200 and facing a bottom surface 110a of the piston 100 may be formed to be spaced apart from the bottom surface 110a by a predetermined distance when the contact part 130 of the receiving part 120 strikes the impact bar 200.

As described above, the impact bar 200 is formed in such a manner that the contact surface 230 of the impact bar 200 faces the bottom surface 110a of the piston 100 at a predetermined distance from the bottom surface 110a when the impact bar 200 is inserted into the receiving part 120 of the piston 100, and the contact part 130 of the piston 100 strikes the impact bar 200. Accordingly, the noise of the receiving part 120 may be attenuated when discharged to the outside.

A buffer part 400 is further provided between the bottom surface 110a and the contact surface 230, and may include a spring.

In other words, although the bottom surface 110a of the piston 100 and the contact surface 230 of the impact bar 200 may be formed to be spaced apart from each other, the bottom surface 110a may strike the contact surface 230 due to the elastic deformation of the piston 100 when impact occurs. Accordingly, since impact may occur, the impact may be buffered by the buffer 400 employing the spring.

In this case, the above-described buffer part 400 may employ the spring as shown in drawings, and may have the shape of a porous cylinder having a specific sectional surface and formed of an elastic material.

As described above, the above impact is reduced by the buffer part 400 to prevent noise and improve durability.

Meanwhile, as shown in FIG. 4, a plurality of heat sinks 500 may be provided on the inner lateral sides of the receiving part 120 or on the outer lateral sides of the impact bar 200.

In other words, the heat sink 500 has a wide surface area to easily radiate heat as well-known to those skilled in the art.

According to the present invention, as described above, a plurality of heat sinks 510 and 520 are provided on the inner lateral sides of the receiving part 120 or the outer lateral sides of the impact bar 200, so that heat emitted from the piston 100 and the impact bar 200 may be easily radiated toward the receiving part 120.

The heat emitted from the piston 100 and the heat sink 500 may be effectively removed by the heat sink 500 according to the present invention so that the strength and the durability may be improved.

Meanwhile, the heat sinks 500 may be formed with mutually different heights. In other words, as described above, the heat sinks 500 are formed on the inner lateral sides of the receiving part 120 or the outer lateral sides of the impact bar 200, and the space defined by the lateral sides is used to propagate noise. Accordingly, if the heat sinks 500 are formed with mutually different heights as described above, noises are mutually cancelled from each other, so that the noise reduction may be increased.

As described above, although the embodiments of the present invention have been described in detail for the illustrative purpose, the present invention is not limited thereto, and it should be understood that modifications or variations can be devised by those skilled in the art that will fall within the spirit and scope of the principles of the disclosure.

The simple modifications or variations fall within the scope of the present invention, and the detailed protection scope of the present invention will be clearly defined by appended claims.

What is claimed is:

1. A low-noise hydraulic hammer comprising:
an impact bar (200) formed in a striking part (300) and inserted into a receiving part (120) in a piston (100),
wherein both inner lateral sides of the receiving part (120) are inclinedly formed such that a diameter of the receiving part (120) is increased toward the impact bar (200), and
the impact bar (200) is received in the receiving part (120) to make contact with the piston (100), formed with a diameter reduced toward the receiving part (120), and spaced apart from the both inner lateral sides of the receiving part (120) by a specific distance.

2. The low-noise hydraulic hammer of claim 1, wherein a contact part (130) serving as a bottom surface of the receiving part (120) and making contact with the impact bar (200) protrudes toward the impact bar (200) by a predetermined height, and is formed at both sides thereof with buffer grooves (140) curved with a predetermined curvature.

3. The low-noise hydraulic hammer of claim 1, wherein the receiving part (120) is provided on one lateral side thereof with a noise insulating material (160).

4. The low-noise hydraulic hammer of claim 1, wherein the impact bar (200) is formed on an outer lateral side thereof with a plurality of steps (220) for attenuation of noise.

5. The low-noise hydraulic hammer of claim 2, wherein a contact surface (230) serving as an outer surface of the impact bar (200) and facing a bottom surface (110a) of the piston (100) is formed to be spaced apart from the bottom surface (110a) by a predetermined distance when the contact part (130) of the receiving part (120) strikes the impact bar (200).

6. The low-noise hydraulic hammer of claim 5, further comprising a buffer part (400) interposed between the bottom surface (110a) and the contact surface (230), wherein the buffer part (400) comprises a spring.

7. The low-noise hydraulic hammer of claim 5, further comprising a buffer part (400) interposed between the bottom surface (110a) and the contact surface (230), wherein the buffer part (400) has a shape of a porous cylinder having a specific sectional surface and including an elastic material.

8. The low-noise hydraulic hammer of claim 5, further comprising a plurality of heat sinks (500) mounted on the inner lateral side of the receiving part (120) or on the outer lateral side of the impact bar (200).

9. The low-noise hydraulic hammer of claim 8, wherein the heat sinks (500) have mutually different heights.
